(19) United States
(12) Patent Application Publication
(10) Pub. No.: US 2015/0345555 A1
(43) Pub. Date: Dec. 3, 2015

(54) JACKETED MAGNETIC BEARING AND ROTARY MACHINE COMPRISING SUCH A BEARING

(71) Applicant: NUOVO PIGNONE SRL, Florence (IT)

(72) Inventors: Manuele BIGI, Florence (IT); Luciano MEI, Florence (IT); Marco ROMANELLI, Florence (IT); Duccio FIORAVANTI, Florence (IT); Marco ANSELMI, Florence (IT)

(21) Appl. No.: 14/653,456

(22) PCT Filed: Dec. 16, 2013
(86) PCT No.: PCT/EP2013/076730

§ 371 Date: Jun. 18, 2015

(30) Foreign Application Priority Data
Dec. 21, 2012 (EP) 12199242.4

(51) Int. Cl. F16C 32/04

(52) U.S. Cl. CPC F16C 32/0476

(57) ABSTRACT

A jacketed magnetic bearing for a rotary machine having a rotor. The jacketed magnetic bearing comprises a stator magnetic circuit secured to a stationary support device, the stator magnetic circuit comprising at least one coil and a ferromagnetic body placed in a metallic protective enclosure. Said protective enclosure comprises an annular support and an annular jacket, the annular support and the annular jacket being welded together. The annular jacket comprises magnetic material and is coated by a protective layer.

### BACKGROUND

The embodiments disclosed relate generally to magnetic bearings for rotary machines having a rotor. In particular, the embodiments relate to magnetic bearings for rotary machines in which the rotor and the bearing are, in use, in contact with a fluid, for instance a gaseous atmosphere, that is corrosive, acid, or carrying particles. Some exemplary embodiments specifically relate to a rotary machine comprising such a magnetic bearing.

Use of magnetic bearings to rotary machines is becoming more and more widespread, in particular in case of corrosive fluid. When the operating fluid of the machine in which the bearing operates is either acid, or corrosive or carrying particles, it is essential to protect the coils of the magnetic bearing and the associated means, by using anti-corrosion protection technologies. An example of such a technology is the jacketed bearing in which the stator portion of the bearing is protected by a metal jacket made of a material that does not oxidize or corrode and in general does not suffer any phenomena related to the aggressiveness of the environment.

A jacket may be in the form of a plate welded to an annular support in which is placed a stator magnetic circuit comprising at least one coil and a ferromagnetic body. The annular support may be made of a stainless material, such as magnetic stainless steel. The jacket of closure plate may be made out of the same material as the annular support, or it may be of a different metallic material, such as nickel base alloy for example.

In order to withstand operating conditions (pressure, fast variations in pressure, temperature, ability to withstand corrosion and abrasion), the jacket generally presents thickness lying in the range of 0.3 to 1 mm or more, for instance in the range of 0.3 to 0.5 mm, i.e. similar to that of the airgap of the magnetic bearing (which is the distance between the stator magnetic circuit and a rotor armature of the bearing). The presence of such a jacket of non-magnetic material thus amounts to increasing the thickness of the airgap of the bearing, which leads to a significant limit on the load available from said bearing. Moreover, it does not totally ensure the lack of contacts between the jacket and the rotor armature of the magnetic bearing, in any conditions.

It is therefore desirable for the thickness of the jacket to be reduced and for the jacket to be constituted by a fine metal sheet. Nevertheless, it requires the use of specific materials having high mechanical properties and anti-corrosion properties, in order to ensure the protection of the stator magnetic circuit against corrosion and to keep the same shape and dimensions in operation.

### SUMMARY OF INVENTION

An object of the present invention is to remedy the above drawbacks while keeping the benefit of the principle of jacketing bearings. In particular, one aim of the invention is to provide a magnetic bearing which is cheaper to build and having a higher loading capacity.

According to a first aspect, in an exemplary embodiment, a jacketed magnetic bearing for a rotary machine having a rotor comprises a stator magnetic circuit secured to a stationary support device. The stator magnetic circuit comprises at least one coil and a ferromagnetic body placed in a metallic protective enclosure. Said protective enclosure comprises an annular support and an annular jacket, the annular support and the annular jacket being welded together. The annular jacket comprises magnetic material, for instance ferromagnetic material, and is coated by a protective layer.

Since the jacket is coated by the protective layer, the material of the jacket may be chosen for its magnetic and mechanical properties: the properties against corrosion are no more relevant. The material of the jacket and the material of the annular support are protected by the protective layer, against corrosion. In particular, the protective layer avoids wet CO₂ corrosion damages on carbon and low alloy steels, and avoids chlorides pitting corrosion damages on stainless steel. It is then possible to choose these materials (having the wanted magnetic and mechanical properties) for the jacket and/or the annular support. Moreover, when the material of the jacket is a ferromagnetic material, it is no more necessary to have a thin jacket to protect the stator magnetic circuit: the jacket may have a larger thickness than a non-magnetic jacket, which reduces the requirements of the material regarding the mechanical properties and the deformation of the jacket in use, leading to a longer lifetime of the bearing and to a smaller airgap.

Therefore, thanks to the use of a protective layer and of a magnetic jacket, it is possible to reduce the airgap, and thus the capabilities of the magnetic bearing of the invention are increased. Moreover, the protective layer can be easily refurbished, during a maintenance step, which allows to improve and to ease the serviceability of the bearing. Furthermore, thanks to the protective layer, it is possible to use for the jacket and/or for the annular support, materials such as carbon and low alloy steels or stainless steel, which are cheap and easy to weld.

In some embodiments, the protective layer may comprise a layer of nickel.

Said layer of nickel may be formed by electroless-nickel plating.

Said layer of nickel may comprise nickel and phosphorus.

In some embodiments, the annular jacket may comprise magnetic material chosen in the group of ferromagnetic material, magnetic stainless steel and nickel base alloy.

In some embodiments, the annular support and the jacket comprise the same material chosen among carbon and low alloy steels and stainless steel. The choice of the same material for both the annular support and the jacket allows to ease the welding step since the materials have the same chemical composition.

According to an embodiment, the bearing is a jacketed axial magnetic bearing. The bearing may comprise a rotor armature in the form of a disk secured to the rotor, and the stator magnetic circuit may be facing said rotor armature.

The rotor and the rotor armature may be, in use, in contact with a fluid, for instance a gaseous atmosphere, that is corrosive, acid, or carrying particles.

In some embodiments, the annular jacket is in contact with the coil and/or the ferromagnetic body.

In some embodiments, the protective enclosure comprises magnetic material and is coated by the protective layer.

According to an embodiment, the annular jacket has a U section with a radial web and two axial flanges. In some embodiments, the material of the radial web and the material of the axial flanges are different. The material of the radial web may be chosen among ferromagnetic materials. The material of axial flanges may be chosen among anti-corrosion materials which may be welded to the annular support.

According to a further aspect, a rotary machine, for example a turbomachinery, may comprise a rotor and a jacketed bearing as previously described.

According to a further aspect, a process to manufacture a bearing as previously described, may comprise the steps of: welding the annular jacket to the annular support and coating the annular jacket with the protective layer.

In some embodiments, the process may comprise the following steps of: coating the annular jacket with the protective layer, performing a heat treatment of the coated annular jacket and then welding the coated annular jacket to the annular support.

### BRIEF DESCRIPTION OF THE DRAWINGS

Other characteristics used appear on reading the following description of particular embodiments of the invention given as examples and with reference to the accompanying drawings, in which:

FIG. 1 is an axial section view on line I-I of FIG. 2, showing a magnetic bearing according to an exemplary embodiment;

FIG. 2 is a radial section view on line II-II of FIG. 1; and

FIG. 3 is an axial section view of a magnetic bearing according to an exemplary embodiment.

### DETAILED DESCRIPTION

The following detailed description of the exemplary embodiments refers to the accompanying drawings. The same reference numbers in different drawings identify the same or similar elements. Additionally, the drawings are not necessarily drawn to scale.

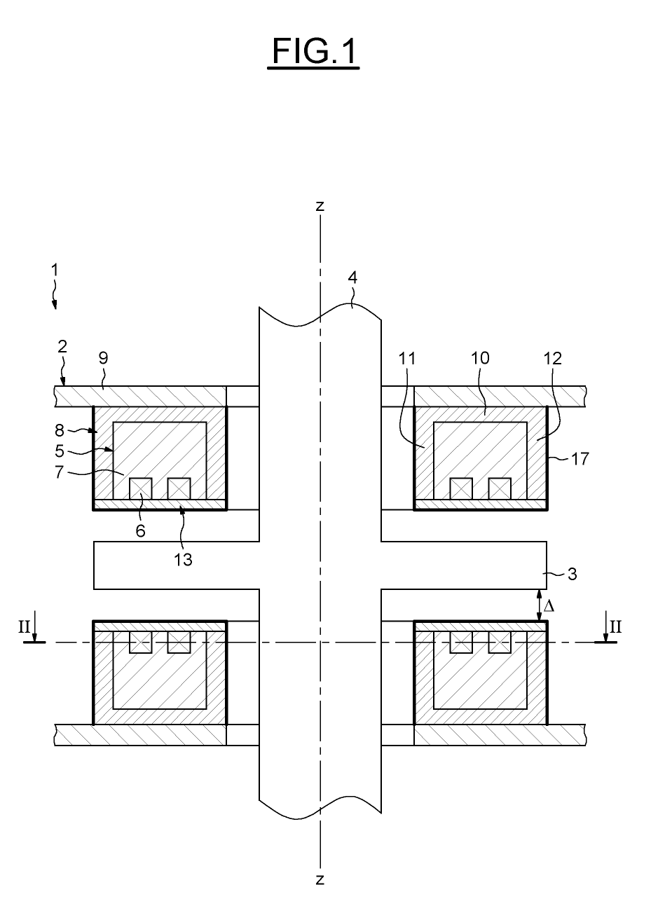

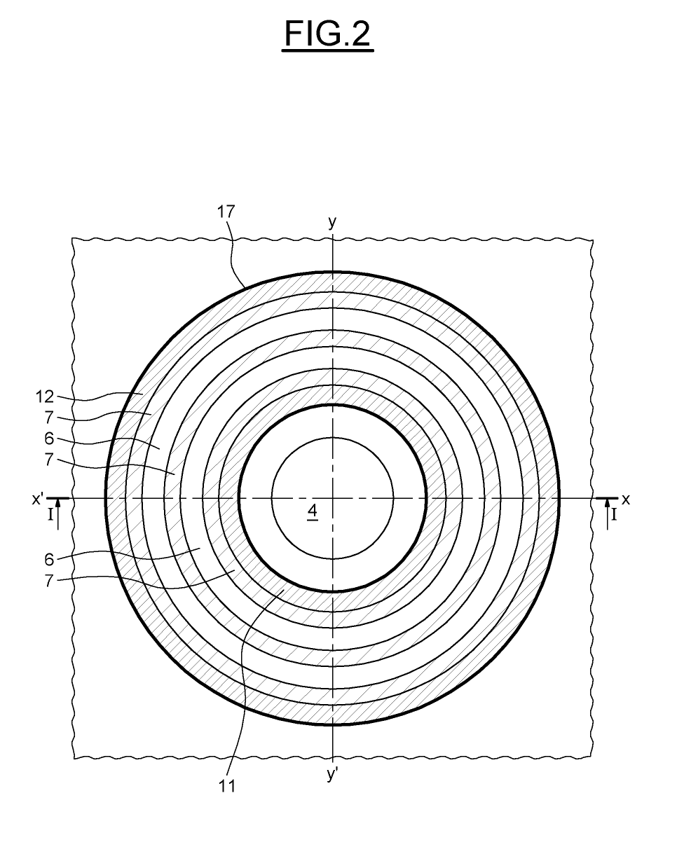

FIGS. 1 and 2 show a first embodiment of an axial jacketed magnetic bearing 1 of the present invention, for a rotary machine. The jacketed magnetic bearing 1 comprises a stator armature 2 and a rotor armature 3 in the form of a disk secured to a rotary shaft 4 of the rotary machine.

The stator armature 2 comprises a stator magnetic circuit 5 including, in conventional manner, one or more annular coils 6 and a ferromagnetic body 7. The ferromagnetic body 7 may be massive or it may be laminated locally. The stator magnetic circuit 5 is placed in a metallic annular support 8 that is itself secured to a stationary support device 9.

The stator magnetic circuit 5 is placed facing the rotor armature 3. The stator armature 2 defines an airgap Δ relative to the rotor armature 3. In some embodiments, the airgap Δ may lie in the range of 0.4 mm to 1.5 mm, and in an embodiment in the range of 0.4 mm to 1.2 mm.

The annular support 8 of the stator magnetic circuit 5 has a U section with a radial web 10 and inner and outer axial flanges 11 and 12. The length of the flanges 11 and 12 in the direction of the axis of the rotary shaft 4 is at least equal to the height of the ferromagnetic body 7 of the stator magnetic circuit 5.

The magnetic bearing 1 also comprises an annular jacket 13. The annular jacket 13 is welded to the annular support 8. The material of the annular jacket 13 is chosen among magnetic materials, and in an embodiment among ferromagnetic materials such as carbon and low alloy steels. In particular, as the jacket is coated by a protective layer to be protected against corrosion, it is no more necessary to use materials with high properties against corrosion: the material of the jacket 13 is chosen according to its magnetic properties and its mechanical properties. In this case, the annular jacket 13 does not increase the airgap between the stator magnetic circuit 5 and the rotor armature 3.

The magnetic bearing 1 also comprises a protective layer 17. The aim of the protective layer 17 is to protect the stator magnetic circuit 5 and the jacket against corrosion. The protective layer 17 is present on the surface of the jacket 13. The protective layer 17 may also cover the external surface of the flanges 11, 12 of the annular support 8.

In some embodiments, the thickness of the protective layer 17 may be in the range of 1 nm to 1 mm, and in an embodiment in the range of 100 nm to 10 μm.

In some embodiments, the protective layer 17 may be a layer of nickel. The layer of nickel may be formed by electroless-nickel plating. The layer of nickel may comprise nickel and phosphorus.

Thanks to the use of the annular jacket 13 and of the protective layer 17, it is possible to get a protection of the stator magnetic circuit 5 against corrosion, while keeping an airgap Δ between the stator magnetic circuit 5 and the rotor armature 3 smaller than in the magnetic bearing of the prior art. In particular, when the annular jacket 13 comprises ferromagnetic material, the airgap Δ is the sum of the distance between the protective layer 17 and the rotor armature 3, and of the thickness of the protective layer 17.

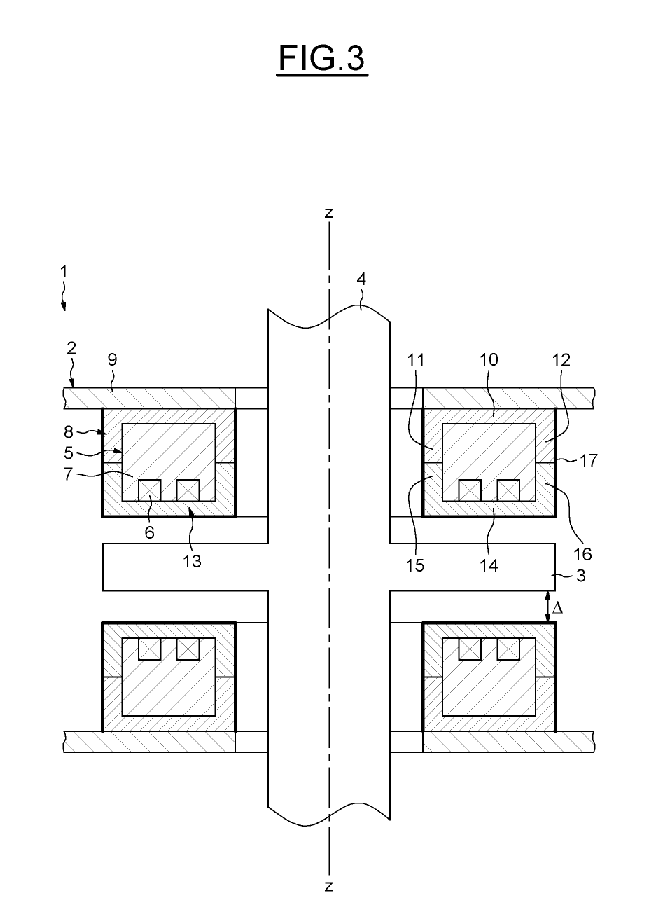

In the exemplary embodiment shown in FIG. 3, an axial jacketed magnetic bearing 1 for a rotary machine comprises an annular jacket 13 having a U section with a radial web 14 and inner and outer axial flanges 15 and 16. The axial flanges 15, 16 of the annular jacket 13 are welded to the flanges 11, 12 of the annular support 8.

In particular, the jacket 13 may comprise two materials: one material for the radial web 14, and one material for the axial flanges 15, 16. The material of the axial flanges 15, 16 is chosen among the materials that can be easily welded and that are resistant against corrosion, for instance nickel-base alloy such as Inconel® 625. The material of the radial web 14 is chosen among the magnetic materials, and in an embodiment among ferromagnetic materials.

In this exemplary embodiment, the material of the axial flanges of the annular jacket 13 has not to be protected against corrosion. In this case, the protective layer 17 may be applied to the surface of the annular jacket 13 before the welding step of the annular jacket 13 onto the annular support 8. Indeed, during the welding step, the protective layer 17 may be removed from the welded parts of the annular jacket, i.e. from the axial flanges 15, 16, but not from the radial web 14. It is then possible to perform a heat treatment (for instance at 600° C.) of the protective layer 17, after the deposition onto the annular jacket 13, and before the welding step of the annular jacket 13 to the annular support 8. The heat treatment before the welding step allows to get a better coating of the protective layer 17 onto the annular jacket 13, while not damaging the coils 6 of the stator magnetic circuit 5. Moreover, the use of specific materials for the flanges 15, 16 of the annular jacket 13 allows to avoid corrosion of said flanges after the removal of the protective from the welding parts during the welding step.

The above description is made with reference to an axial type magnetic bearing. However, it can be applied in like manner to a magnetic bearing of radial type or to a magnetic bearing of conical type combining the functions of a radial bearing and of an axial bearing.

What is claimed is:

1. A jacketed magnetic bearing for a rotary machine having a rotor, the bearing comprising:
a stator magnetic circuit secured to a stationary support device, said stator magnetic circuit comprising at least one coil and a ferromagnetic body placed in a metallic protective enclosure, wherein said protective enclosure comprises an annular support and an annular jacket, said annular support and the said annular jacket being welded together,
wherein said annular jacket comprises magnetic material and is coated by a protective layer.

2. The bearing according to claim 1, wherein said protective layer comprises a layer of nickel.

3. The bearing according to claim 2, wherein said layer of nickel is formed by electroless-nickel plating.

4. The bearing according to claim 2, wherein said layer of nickel comprises nickel and phosphorus.

5. The bearing according to claim 1, wherein said annular jacket further comprises magnetic material selected from the group consisting of ferromagnetic material, magnetic stainless steelₛ and nickel base alloy.

6. The bearing according to claim 1, wherein said bearing is a jacketed axial magnetic bearing.

7. The bearing according to claim 1, further comprising a rotor armature in the form of a disk secured to said rotor, and wherein said stator magnetic circuit is facing said rotor armature.

8. The bearing according to claim 7, wherein said rotor and said rotor armature are, in use, in contact with a fluid, for instance a gaseous atmosphere, that is corrosive, acid, or carrying particles.

9. The bearing according to claim 1, wherein said annular jacket is in contact with said coil and/or said ferromagnetic body.

10. The bearing according to claim 1, wherein said protective enclosure further comprises magnetic material and is coated by said protective layer.

11. A rotary machine comprising:
a rotor; and
a bearing comprising:
a stator magnetic circuit secured to a stationary support device, said stator magnetic circuit comprising at least one coil and a ferromagnetic body placed in a metallic protective enclosure, wherein said protective enclosure comprises an annular support and an annular jacket, said annular support and said annular jacket being welded together,
wherein said annular jacket comprises magnetic material and is coated by a protective layer.

12. A method for manufacturing a bearing comprising a stator magnetic circuit secured to a stationary support device, said stator magnetic circuit comprising at least one coil and a ferromagnetic body placed in a metallic protective enclosure, wherein said protective enclosure comprises an annular support and an annular jacket, the method comprising:
welding said annular jacket to said annular support; and
coating said annular jacket with a protective layer.

13. The method according to claim 12, wherein said annular jacket has a U section with a radial web and two axial flanges, said two flanges comprising a nickel base alloy, the method further comprising:
coating said annular jacket with said protective layer;
performing a heat treatment of said coated annular jacket; and
welding said coated annular jacket to said annular support.

14. The bearing according to claim 2, wherein said layer of nickel comprises nickel and phosphorus.

15. The bearing according to claim 14, wherein said annular jacket further comprises magnetic material selected from the group consisting of ferromagnetic material, magnetic stainless steel, and nickel base alloy.

16. The bearing according to claim 15, wherein said bearing is a jacketed axial magnetic bearing.

17. The bearing according to claim 16, further comprising a rotor armature in the form of a disk secured to said rotor, and wherein said stator magnetic circuit is facing said rotor armature.

18. The bearing according to claim 17, wherein said rotor and said rotor armature are, in use, in contact with a fluid, for instance a gaseous atmosphere, that is corrosive, acid, or carrying particles.

19. The bearing according to claim 18, wherein said annular jacket is in contact with said coil and/or said ferromagnetic body.

20. The bearing according to claim 19, wherein said protective enclosure further comprises magnetic material and is coated by said protective layer.
